(19) United States
(12) Patent Application Publication
(10) Pub. No.: US 2022/0349192 A1
(43) Pub. Date: Nov. 3, 2022

(54) 3D PRINTER FOR BUILDING CONSTRUCTION, AND SYSTEM AND METHOD TO MAINTAIN THE SAME IN HORIZONTAL ORIENTATION

(71) Applicants: Hisys Co., Ltd., Gimpo (KR); Black Buffalo 3D Corporation, New York, NY (US)

(72) Inventor: CHANGWOO JOO, Incheon (KR)

(21) Appl. No.: 17/734,096

(22) Filed: May 1, 2022

Related U.S. Application Data
(60) Provisional application No. 63/183,044, filed on May 2, 2021.

(51) Int. Cl. E04G 21/04

(52) U.S. Cl. CPC E04G 21/0445; E04G 21/0427; B33Y 30/00

(57) ABSTRACT

An automatic leveling system to maintain a 3D printer for building construction components in a substantially horizontal orientation includes: a support structure to support on a ground surface at least two columns each being supportable at a variable distance above the ground surface; a signal generator to generate a rotatable signal in a substantially horizontal plane; and sensors mounted on the columns to detect the rotatable signal. The variable distances are adjustable based on the detection of the rotatable signal by the sensors.

### CROSS-REFERENCE TO RELATED APPLICATION

This application claims priority from and the benefit of U.S. Provisional Patent Application No. 63/183,044, filed on May 2, 2021, which is hereby incorporated by reference for all purposes as if fully set forth herein.

### BACKGROUND

### Field

The invention relates generally to 3D printers used in the construction industry and, more particularly, to an automatic leveling system for such 3D printers.

### Discussion of the Background

In building components made by a 3D printer to construct buildings, it is important to precisely detect and/or measure the height of a building structure from the ground as it is being erected. Accordingly, a 3D printer for making the building construction components should be installed on the ground in a stable horizontal orientation.

Outriggers may be used to maintain facilities or equipment such as vehicles in a horizontal orientation. For example, a conventional leveling system includes: outriggers installed on the front, rear, left, and right sides of the facility; a height adjusting device to adjust heights of portions of the facility supported by the outriggers; an inclinometer installed on the facility; a controller to control the height adjusting device based on output signals of the inclinometer to maintain the facility in a horizontal orientation; PLC (Programmable Logic Controller) to control the controller and communicate information with a touch screen; the touch screen, which is an input device, to display texts and/or pictures and provide commands to the PLC in response to recognition of a part where a user touches to execute a desired instruction and/or program.

The 3D printer may include a leveling system to maintain the 3D printer in a horizontal orientation. For example, the leveling system level the 3D printer in a horizontal orientation by supporting the 3D printer with outriggers, and adjusting heights of portions of the 3D printer supported by outriggers based on an inclinometer that is installed on the 3D printer and outputs signals indicating an angle of slope or elevation of the 3D printer.

The above information disclosed in this Background section is only for understanding of the background of the inventive concepts, and, therefore, it may contain information that does not constitute prior art.

### SUMMARY

Applicant discovered that, in a case where a 3D printer includes a conventional leveling system, the leveling system may not ensure horizontality of the 3D printer. For example, the leveling system performs leveling the 3D printer only depending on output signals of an inclinometer installed on a body of the 3D printer, and in this case the accuracy of the leveling may be relatively low and the 3D printer may be tilted. Building construction components and structures made by a tilted 3D printer may have a relatively low reliability.

3D printers and 3D printer systems for building construction components constructed according to the principles and illustrative embodiments of the invention are capable of maintaining horizontality at a desired height from the ground with relatively high accuracy. For example, the 3D printer may have an automatic leveling system, which includes a signal generator to generate a rotatable signal at a desired height in a substantially horizontal plane, and sensors to detect the rotatable signal at ground supports of the 3D printer. The 3D printer may be leveled in a substantially horizontal orientation by adjusting lengths and/or heights of the ground supports above the ground based on the detected rotatable signal. Building construction components made from a 3D printer having an automatic leveling system that maintains a relatively high degree of horizontality may build construction components having relatively high reliability.

Methods of maintaining a 3D printer for building construction components in a substantially horizontal orientation according to the principles and illustrative embodiments of the invention are capable of maintaining the 3D printers in a substantially horizontal orientation at a desired height from the ground with relatively high accuracy. For example, the method may adjust the lengths and/or heights of ground supports of the 3D printer based upon detection of a rotatable signal generated in a substantially horizontal plane.

Additional features of the inventive concepts will be set forth in the description which follows, and in part will be apparent from the description, or may be learned by practice of the inventive concepts.

According to one aspect of the invention, an automatic leveling system to maintain a 3D printer for building construction components in a substantially horizontal orientation includes: a support structure to support on a ground surface at least two columns each being supportable at a variable distance above the ground surface; a signal generator to generate a rotatable signal in a substantially horizontal plane; and sensors mounted on the columns to detect the rotatable signal. The variable distances are adjustable based on the detection of the rotatable signal by the sensors.

The columns may include legs having substantially constant lengths and a height adjusting mechanism to adjust the variable distances independently based on the detection of the rotatable signal at the sensors.

The support structure may include: base members to horizontally support the columns; and outriggers to horizontally fix the base members to the ground surface.

The rotatable signal may include a laser signal and the signal generator may include a laser generator to generate the laser signal.

At least one of the sensors may include a first light sensor disposed above the ground surface and a second light sensor disposed closer to the ground surface than the first light sensor.

The automatic leveling system may further include a height level controller to generate: a first control signal to increase the variable distance of one of the columns connected to the first light sensor in response to detection of the rotatable signal at the first light sensor; and a second control signal to decrease the variable distance of one of the columns connected to the second light sensor in response to detection of the rotatable signal at the second light sensor.

The at least one of the sensors may further include a third light sensor disposed between the first and second light sensors; and the height level controller may be configured to maintain the variable distance of one of the columns connected to the third light sensor substantially constant in response to detection of the rotatable signal at the third light sensor.

The automatic leveling system may further include convex lenses to direct the rotatable signal to the sensors, respectively.

The automatic leveling system may further include: a servo motor to rotate in response to a control signal based on one of the sensors detecting the rotatable signal; and a screw jack engaged with the servo motor to increase or decrease the variable distance of one of the columns connected to the one of the sensors in response to the rotation of the servo motor.

The automatic leveling system may further include a LiDAR (Light Detection And Ranging) sensor to at least partially scan one or more of a construction site and the 3D printer to generate scan data to control the 3D printer.

The automatic leveling system of claim 10 in combination with a 3D printer for building construction may further include: a nozzle to discharge materials to build the construction components; frame shafts connected to the columns to support the nozzle; a moving mechanism supported by the columns and the frame shafts to move the nozzle relative to the support structure; and a main controller to receive the scan data and to control the moving mechanism and the nozzle based on the scan data.

The main controller may be configured to recognize, based on the scan data, at least one event of a difference in elevation of regions of the ground surface, construction errors of at least one of the construction components, and deformation of at least one of portions of the columns and the frame shafts, and to control the moving mechanism and the nozzle in response to the recognized event.

The main controller may be configured to control the LiDAR sensor to generate the scan data when the moving mechanism moves relative to the support structure and to adjust, based on the scan data, at least one of amounts of material discharged by the nozzle, a path of movement of the nozzle, a speed of the movement of the nozzle.

According to another aspect of the invention, a method of maintaining a 3D printer for building construction components in a substantially horizontal orientation includes the steps of: supporting the 3D printer on a ground surface with at least two members being adjustable at variable distances above the ground surface; generating a rotatable signal in a substantially horizontal plane; detecting the rotatable signal at each of the members; and adjusting the variable distances based upon the detection of the rotatable signal.

The rotatable signal may include a laser signal.

The step of detecting the rotatable signal may include detecting the rotatable signal at first and second light sensors disposed at different heights relative to the ground surface; and the step of adjusting the columns may include: increasing the variable distance of one of the members when the rotatable signal is detected at the first light sensor; and decreasing the variable distance of one of the members when the rotatable signal is detected at the second light sensor.

The step of adjusting the variable distances may further include: maintaining the variable distance of one of the members substantially constant when the rotatable signal is detected at a third light sensor disposed between the first and second light sensors.

The step of detecting the rotatable signal may include: directing the rotatable signal to sensors with convex lenses; and the step of adjusting the variable distances includes generating an alert signal when one of the sensors fails to detect the rotatable signal.

The method may further include the steps of i) generating scan data by at least partially scanning one or more of a construction site and the 3D printer using a LiDAR sensor after the variable distances are adjusted; and ii) controlling the 3D printer to build the construction components based upon the scan data.

According to still another aspect of the invention, a 3D printer system for building construction components to maintain the 3D printer in a substantially horizontal orientation include: at least two outriggers to support on a ground surface at least two members of a frame supporting the 3D printer; a signal generator to generate a rotatable signal in a substantially horizontal plane; sensors disposed on the members to detect the rotatable signal; and a height adjusting mechanism to adjust heights of the members independently based on the sensors detecting the rotatable signal.

It is to be understood that both the foregoing general description and the following detailed description are illustrative and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate illustrative embodiments of the invention, and together with the description serve to explain the inventive concepts.

FIG. 1 is a perspective view of an embodiment of a 3D printer system for building construction components including an automatic leveling system constructed according to the principles of the invention.

FIG. 2 is a cross-sectional view of the 3D printer system of FIG. 1.

FIG. 3 is an enlarged view of region A of FIG. 2.

FIG. 4 is a block diagram of an embodiment of the control device of FIG. 1 that communicates with sensing devices of legs of the 3D printer system.

FIG. 5 is a perspective view of another embodiment of a 3D printer system for building construction components including an automatic leveling system constructed according to the principles of the invention.

FIG. 6 is a block diagram of another embodiment of the control device of FIG. 5 that communicates with a LiDAR sensor of the 3D printer system.

FIG. 7 is a cross-sectional view of the 3D printer system of FIG. 5.

FIG. 8 is a side view of the 3D printer system of FIG. 5 viewed along the first direction D1.

FIG. 9 is a flowchart of an embodiment of a method of maintaining a 3D printer system for building construction components in a substantially horizontal orientation according to the principles of the invention.

FIG. 10 is a flowchart of an embodiment of step S930 of FIG. 9.

FIG. 11 is a flowchart of an embodiment of step S940 of FIG. 9.

FIG. 12 is a flowchart of an embodiment of a method of controlling a 3D printer after horizontality of the 3D printer is adjusted.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing illustrative features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

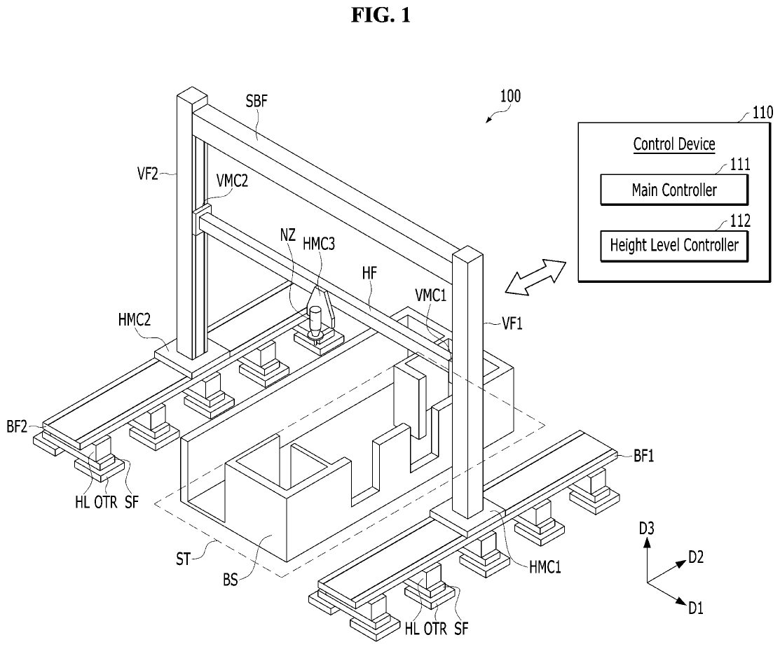

FIG. 1 is a perspective view of an embodiment of a 3D printer system for building construction components including an automatic leveling system constructed according to the principles of the invention.

Referring to FIG. 1, a 3D printer system 100 includes outriggers OTR, support frames SF, height levelers HL, first and second base frames BF1 and BF2, first and second vertical frame shafts VF1 and VF2, first and second horizontal movement carriages HMC1 and HMC2, a horizontal frame shaft HF, first and second vertical movement carriages VMC1 and VMC2, a nozzle assembly NZ, a third horizontal movement carriage HMC3, and a control device 110.

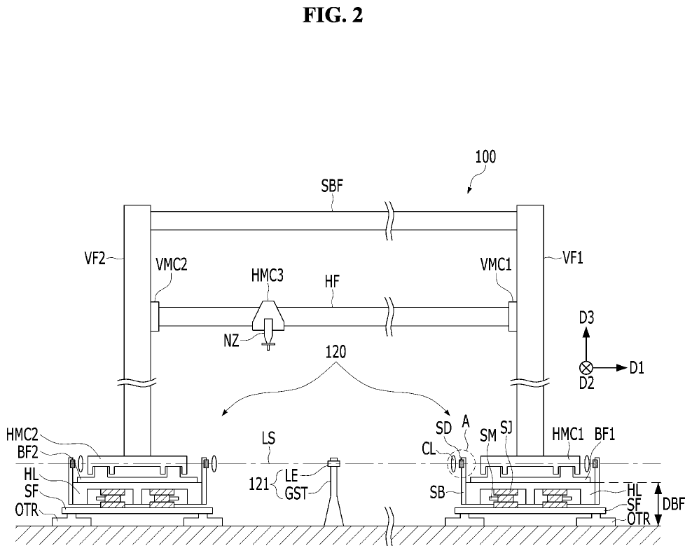

The 3D printer system 100 includes an automatic leveling system 120 (see FIG. 2) to maintain the 3D printer system 100 in a substantially horizontal orientation. For example, first and second base frames BF1 and BF2 may be horizontally oriented along a horizontal plane even if the ground surface is angled relative to the horizontal plane. The horizontal plane may be a plane substantially perpendicular to the direction of gravity and be substantially parallel with first and second axial directions D1 and D2. The horizontally oriented 3D printer system 100 may build a structure BS in a site ST as desired with a relatively low errors or tolerances since the structure BS is also required to be horizontally oriented. The automatic leveling system may include some of elements of the 3D printer system 100, such as the outriggers OTR, the support frames SF, the height levelers HL, the first and second base frames BF1 and BF2, and first and second vertical frame shafts VF1 and VF2. The automatic leveling system will be described in detail with reference to FIG. 2.

A support structure of the 3D printer system 100, which may be in the form of the outriggers OTR and support frames SF, supports the first and second base frames BF1 and BF2 and the first and second vertical frame shafts VF1 and VF2 on the ground surface. The support frames SF may be provided as base members of the 3D printer system 100, which support the first and second base frames BF1 and BF2 and the first and second vertical frame shafts VF1 and VF2 horizontally. The outriggers OTR horizontally fix the support frames SF to the ground.

A height adjusting mechanism, which may be in the form of the height levelers HL, supports elements of the 3D printer system 100 disposed thereon, such as the first and second base frames BF1 and BF2 and the first and second vertical frame shafts VF1 and VF2, at adjustable distances above the ground surface. In an embodiment, the height levelers HL may be disposed between the support frames SF and the first and second base frames BF1 and BF2 to support the first and second base frames BF1 and BF2. In this case, the height levelers HL may adjust the distances (or heights of the first and second base frames BF1 and BF2 from the ground) between the first and second base frames BF1 and BF2 and the ground. In an embodiment, the 3D printer system 100 may include the same number of the height levelers HL as the outriggers OTR.

The first and second base frames BF1 and BF2 are spaced apart from each other in the first direction and parallel with each other, and each of the first and second base frames BF1 and BF2 generally extends in the second direction D2 intersecting the first direction D1. The first and second base frames BF1 and BF2 may be disposed on the height levelers HL, and may support the first and second vertical frame shafts VF1 and VF2 to be linearly movable in the second direction D2. In an embodiment, the first and second base frames BF1 and BF2 each may include one or more guide rails protruding from its body and extending in the second direction D2 to guide linear movement of one of the first and second vertical frame shafts VF1 and VF2.

Legs of the 3D printer system 100, which may be in the form of a pair of the first and second vertical frame shafts VF1 and VF2, are disposed on the first and second base frames BF1 and BF2. The first and second vertical frame shafts VF1 and VF2 each may extend in a third direction D3 intersecting the first and second directions D1 and D2. The first and second vertical frame shafts VF1 and VF2 are linearly movable along the first and second base frames BF1 and BF2. In an embodiment, the first horizontal movement carriage HMC1 may be disposed between the first base frame BF1 and the first vertical frame shaft VF1 to move the first vertical frame shaft VF1 along the first base frame BF1, and the second horizontal movement carriage HMC2 may be disposed between the second base frame BF1 and the second vertical frame shaft VF2 to move the second vertical frame shaft VF2 along the second base frame BF1.

The 3D printer system 100 may further include one or more sub frame shafts SBF to improve and/or complement the rigidity of the first and second vertical frame shafts VF1 and VF2. The one or more sub frame shafts SBF is shown as being horizontally disposed between the first and second vertical frame shafts VF1 and VF2.

The horizontal frame shaft HF extends in the first direction D1 and is supported by the first and second vertical frame shafts VF1 and VF2. The horizontal frame shaft HF may be engaged with the first and second vertical frame shafts VF1 and VF2 to be linearly moveable in the third direction D3. In an embodiment, the first vertical movement carriage VMC1 is disposed between the first vertical frame shaft VF1 and the horizontal frame shaft HF, and the second vertical movement carriage VMC2 is disposed between the second vertical frame shaft VF2 and the horizontal frame shaft HF. The horizontal frame shaft HF supports the nozzle assembly NZ.

The nozzle assembly NZ is disposed on the horizontal frame shaft HF to be linearly moveable in the first direction D1. In an embodiment, the third horizontal movement carriage HMC3 is disposed between the nozzle assembly NZ and the horizontal frame shaft HF to move the nozzle assembly NZ along the horizontal frame shaft HF. The nozzle assembly NZ may be connected through a supply line to a material storage tank that stores materials corresponding to the structure BS, and may discharge the materials of the material tank in response to control signals from the control device 110.

The control device 110 controls the overall operation of the 3D printer system 100. The control device 110 may include a main controller 111 and a height level controller 112. The main controller 111 may move the nozzle assembly NZ by moving the first and second vertical frame shafts VF1 and VF2 in the second direction D2, moving the horizontal frame shaft HF in the third direction D3, and moving the nozzle assembly NZ in the first direction D1. In other words, the main controller 111 may control the first and second horizontal movement carriages HMC1 and HMC2 to move along the first and second base frames BF1 and BF2, and control the first and second vertical movement carriages VMC1 and VMC2 to move along the first and second vertical frame shafts VF1 and VF2, and control the third horizontal movement carriage HMC3 to move along the horizontal frame shaft HF. As such, the main controller 111 may move the first and second vertical frame shafts VF1 and VF2, the horizontal frame shaft HF, and the nozzle assembly NZ to change a position of the nozzle assembly NZ, and may control the nozzle assembly NZ to discharge the materials to form components of the building structure BS.

The height level controller 112 controls the height levelers HL to adjust the variable distances between the first and second base frames BF1 and BF2 and the ground to maintain the 3D printer system 100 in a substantially horizontal orientation.

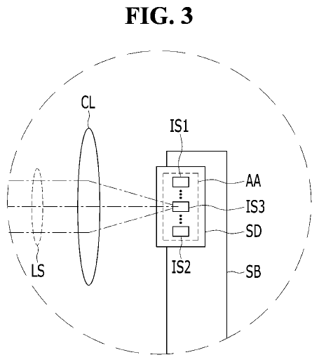

FIG. 2 is a cross-sectional view of the 3D printer system of FIG. 1 including an automatic leveling system. FIG. 3 is an enlarged view of region A of FIG. 2.

Referring to FIG. 2, the 3D printer system 100 includes an automatic leveling system 120 to maintain the 3D printer system 100 in a substantially horizontal orientation. The automatic leveling system 120 may include the outriggers OTR, the support frames SF, the height levelers HL, the first and second base frames BF1 and BF2, and the first and second vertical frame shafts VF1 and VF2 described with reference to FIG. 1.

Each of the height levelers HL may include at least one servo motor SM and at least one screw jack SJ engaged with the at least one servo motor SM. The servo motor SM may rotate clockwise/counter-clockwise in response to control signals of the height level controller 112 of the control device 110 of FIG. 1. The screw jack SJ may raise or lower the body of the height leveler HL to increase or decrease a distance DBF between the ground and an upper surface of the height leveler HL in the third direction D3, in response to the rotation of the servo motor SM. In an embodiment, when the control device 110 receives a desired height from the user, the height level controller 111 may control the servo motor SM to drive screw jack SJ to simultaneously set the distance DBF of each of upper surfaces of the height levelers HL as the desired height.

The automatic leveling system 120 further includes a signal generator, which may be in the form of a laser generator 121, to generate a rotatable signal in a substantially horizontal plane of the first and second directions D1 and D2. The laser generator 121 may include a gyroscope sensor tripod GST and a laser emitter LE. The gyroscope sensor tripod GST may include a body portion rotatable at a high speed, and a gyroscope sensor able to measure the orientation and angular velocity of the body portion to maintain the body portion in a substantially horizontal orientation even if the ground surface is angled relative to the horizontal plane. The laser emitter LE may be fixed on the body portion and emit a laser signal LS. Accordingly, the laser emitter LE may generate a rotating laser signal LS at a high speed in the horizontal plane due to rotation of the body portion at high speed. For example, the laser generator 121 may be provided as one of various kinds of commercially available self-leveling horizontal rotary laser generators, such as “RL-H5A” model of Topcon, “LL500” model of Spectra, “Rugby 610” model of Leica, etc.

The automatic leveling system 120 further includes a sensing device SD mounted on each of columns of the 3D printer system 100. Here, the columns of the 3D printer system 100 may be structures that stand substantially vertically on the support frames SF to support other elements of the 3D printer system 100, such as the horizontal frame shaft HF and the sub frame shaft SBF. In an embodiment, the columns of the 3D printer system 100 may include the first and second vertical frame shafts VF1 and VF2 and height levelers HL. A sensor bracket SB may be provided to mount the sensing device SD on each of the height levelers HL, and the sensing device SD may be positioned on the sensor bracket SB at a given height to be suitable for receiving the laser signal LS emitted from the laser generator 121. In an embodiment, the automatic leveling system 120 may further include a convex lens CL to direct the laser signal LS to the sensing device SD at each of the sensor bracket SB.

The sensing device SD may detect the laser signal LS and transfer data and/or signals to the height level controller 112 based on the detection of the laser signal LS. Referring to FIG. 3, the sensing device SD includes an active area AA able to detect a light signal. In an embodiment, the sensing device SD may include a plurality of light sensors in the active area AA and arranged in the third direction DR3. Any known light sensing device capable of sensing the rotatable light signal described herein may be used, such as [given examples]. For example, the sensing device SD may include an upper light sensor IS1, a lower light sensor IS2, and a center light sensor IS3. The lower light sensor IS2 is disposed closer to the ground than the upper light sensor IS1, and the center light sensor IS3 is disposed between the upper light sensor IS1 and lower light sensor IS2. The upper, lower, and center light sensors IS1 to IS3 may detect a light signal having a specific wavelength, which may be the laser signal LS. In response to detection of the laser signal LS at one of the upper, lower, and center light sensors IS1 to IS3, the sensing device SD may transfer to the height level controller 112 data and/or signals indicating a positional value and/or a coordinate of one of the upper, lower, and center light sensors IS1 to IS3 in which the laser signal LS is detected.

Referring back to FIG. 2 together with FIG. 3, in response to detection of the laser signal LS at the upper light sensor IS1 the height level controller 112 may control the servo motor SM connected to the upper light sensor IS1 such that the screw jack SJ engaged with the servo motor SM increases the distance DBF. In response to detection of the laser signal LS at the lower light sensor IS2 the height level controller 112 may control the servo motor SM connected to the lower light sensor IS2 such that the screw jack SJ decreases the distance DBF. In this way, the height level controller 112 may adjust the distance DBF until the laser signal LS is detected by the center light sensor IS3. As such, the height level controller 112 may adjust the distance DBF of each of the height levelers HL independently based on detection of the laser signal LS at the sensing device SD. Accordingly, the upper surfaces of the height levelers HL may be horizontally oriented to be substantially parallel with the horizontal plane of the laser signal LS, and the first and second base frames BF1 and BF2 and the first and second vertical frame shafts VF1 and VF2 may be horizontally oriented.

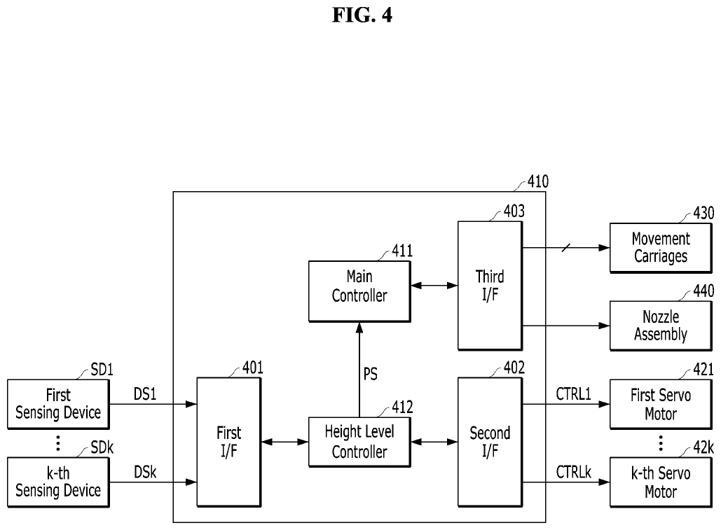

FIG. 4 is a block diagram of an embodiment of the control device of FIG. 1 that communicates with sensing devices of legs of the 3D printer system.

Referring to FIGS. 2 and 4, first to k-th sensing devices SD1 to SDk, which are disposed respectively on the height levelers HL, may provide first to k-th detection signals DS1 to DSk to a control device 410. The first to k-th sensing device SD1 to SDk may detect the laser signal LS through a plurality of light sensors such as the upper, lower, and center light sensors IS1 to IS3 of FIG. 3, and may transfer the first to k-th detection signals DS1 to DSk to the control device 410, respectively, based upon the detection of the laser signal LS. The first to k-th detection signals DS1 to DSk each may indicate a positional value and/or a coordinate of one of the upper, lower, and center light sensors IS1 to IS3 in which the laser signal LS is detected.

The control device 410 may include a first interface 401, a second interface 402, a third interface 403, a main controller 411, and a height level controller 412. The first interface 401 may provide the height level controller 412 with an interface with the first to k-th sensing devices SD1 to SDk. The second interface 402 may provide the height level controller 412 with an interface with first to k-th servo motors 421 to 42k. The first to k-th servo motors 421 to 42k may be the servo motors SM of the height levelers HL of FIG. 2, connected to the first to k-th sensing devices SD1 to SDk, respectively.

The height level controller 412 may be connected to the first and second interfaces 401 and 402 and the main controller 411. The height level controller 412 receives the first to k-th detection signals DS1 to DSk respectively from the first to k-th sensing devices SD1 to SDk through the first interface 401. The height level controller 412 provides first to k-th control signals CTRL1 to CTRLk respectively to the first to k-th servo motors 421 to 42k through the second interface 402 based on the first to k-th detection signals DS1 to DSk.

Each of the first to k-th control signals CTRL1 to CTRLk may control a corresponding one of the first to k-th servo motors 421 to 42k to increase and decease the distance DBF between the ground and the upper surface of the height leveler HL. For example, the height level controller 412 may generate an x-th control signal CTRLx to increase the distance DBF when an x-th detection signal DSx indicates that the upper light sensor IS1 of an x-th sensing device SDx detects the laser signal LS, where x is an integer equal to or greater than 1 and equal to or less than k. For example, the height level controller 412 may generate a y-th control signal CTRLy to decrease the distance DBF when a y-th detection signal DSy indicates that the lower light sensor IS2 of an y-th sensing device SDy detects the laser signal LS, where y is an integer equal to or greater than 1 and equal to or less than k. For example, the height level controller 412 may disable a z-th control signal CTRLz to maintain the distance DBF when a z-th detection signal DSz indicates that the center light sensor IS3 of an z-th sensing device SDz detects the laser signal LS, where z is an integer equal to or greater than 1 and equal to or less than k.

The height level controller 412 may generate a pass signal PS when all the first to k-th detection signals DS1 to DSk indicates that the center light sensor IS3 detects the laser signal LS, which means that the upper surfaces of the height levelers HL may be horizontally oriented in parallel with the horizontal plane of the laser signal LS. As such, the height level controller 412 may adjust the distance DBF at each of the height levelers HL independently on the basis of the laser signal LS, thereby improving horizontality of the 3D printer system 100.

The main controller 411 may be connected to the height level controller 412 and the third interface 403. The third interface 403 may provide the main controller 411 with an interface to provide control signals to the movement carriages 430 and nozzle assembly 440. The movement carriages 430 may include the first and second horizontal movement carriages HMC1 and HMC2, the first and second vertical movement carriages VMC1 and VMC2, and the third horizontal movement carriage HMC3 of FIG. 1, and the nozzle assembly 440 may include the nozzle assembly NZ of FIG. 1.

The main controller 411 may start building construction components, such as walls, columns, floors, etc., by controlling the movement carriages 430 and the nozzle assembly 440 when the pass signal PS is enabled. The main controller 411 may control the nozzle assembly 440 to discharge materials while controlling the movement carriages 430 to move the nozzle assembly 440 to build construction components. In an embodiment, the main controller 411 may output, through output devices such as display and/or audio devices, a perceivable signal informing the user that the 3D printer system 100 is horizontally oriented when the pass signal PS is enabled.

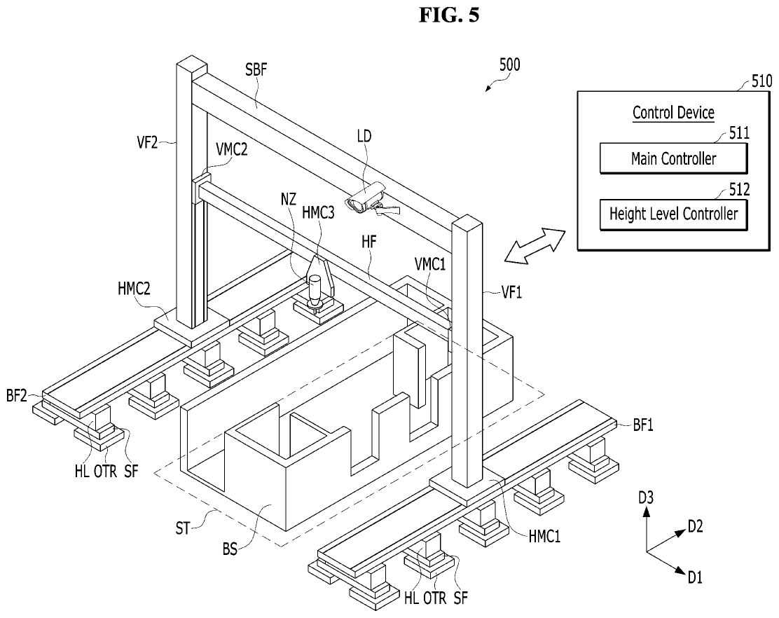

FIG. 5 is a perspective view of another embodiment of a 3D printer system for building construction components including an automatic leveling system constructed according to the principles of the invention.

Referring to FIG. 5, a 3D printer system 500 includes outriggers OTR, support frames SF, height levelers HL, first and second base frames BF1 and BF2, first and second vertical frame shafts VF1 and VF2, first and second horizontal movement carriages HMC1 and HMC2, a horizontal frame shaft HF, first and second vertical movement carriages VMC1 and VMC2, a sub frame shaft SBF, a nozzle assembly NZ, a third horizontal movement carriage HMC3, a control device 510, and a LiDAR (Light Detection And Ranging) sensor LD

The outriggers OTR, the support frames SF, the height levelers HL, the first and second base frames BF1 and BF2, the first and second vertical frame shafts VF1 and VF2, the first and second horizontal movement carriages HMC1 and HMC2, the horizontal frame shaft HF, the first and second vertical movement carriages VMC1 and VMC2, the sub frame shaft SBF, the nozzle assembly NZ, and the third horizontal movement carriage HMC3 may be configured the same as those of the 3D printer system 100 of FIG. 1. Repetitive descriptions will be omitted to avoid redundancy.

The 3D printer system 500 further includes the LiDAR sensor LD (or Laser Detection And Ranging: LADAR) to scan a site ST of construction and a desired portion of the 3D printer system 500 such as frame shafts VF1, VF2, and HF to generate scan data. Any commercially available LiDAR or LADAD sensor may be used. The LiDAR sensor LD may scan to generate the scan data in the manner well known in the art. For example, the LiDAR sensor LD may generate optical pulses and then measures the characteristics of the reflected optical pulses such as pulse powers, round trip times, phase shifts, pulse widths, etc. to detect and define objects in the field of view to generate the scan data.

In an embodiment, the LiDAR sensor LD may be fixed on one of the frame shafts VF1, VF2, HF, and SBF, such as the sub frame shaft SBF as shown in FIG. 5 to face the site ST of construction and a desired portion of the 3D printer system 500.

The control device 510 communicates with the LiDAR sensor LD to receive the scan data. The control device 510 includes a main controller 511 and a height level controller 512. The main controller 511 controls the first and second horizontal movement carriages HMC1 and HMC2, the first and second vertical movement carriages VMC1 and VMC2, the third horizontal movement carriage HMC3, and the nozzle assembly NZ based on the scan data. The height level controller 512 controls the height levelers HL to adjust distances between the upper surfaces of the height levelers HL and the ground to maintain the 3D printer system 500 in a substantially horizontal orientation, as discussed above.

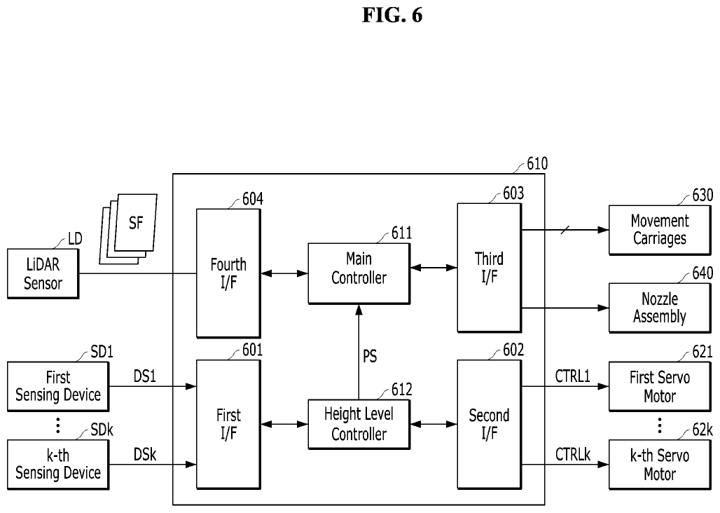

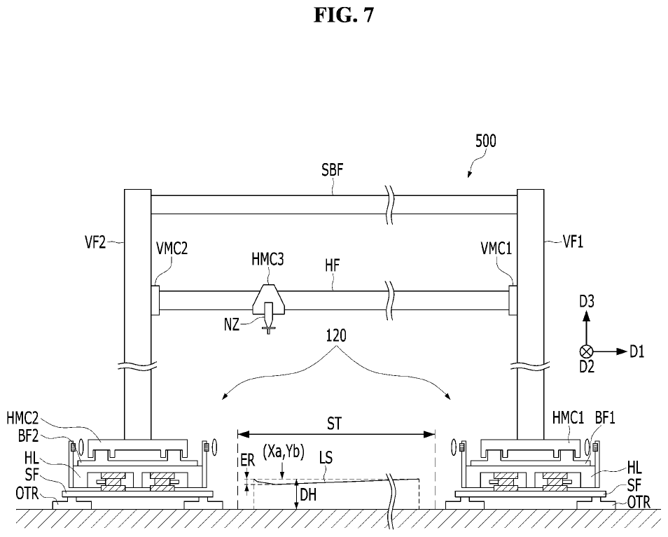

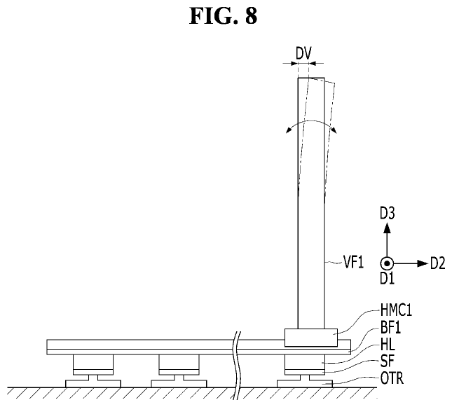

FIG. 6 is a block diagram of another embodiment of the control device of FIG. 5 that communicates with a LiDAR sensor of the 3D printer system. FIG. 7 is a cross-sectional view of the 3D printer system of FIG. 5. FIG. 8 is a side view of the 3D printer system of FIG. 5 viewed along the first direction D1.

Referring to FIGS. 5 and 6, a control device 610 may include first to fourth interfaces 601 to 604, a main controller 611, and a height level controller 612. The main controller 611 and the height level controller 612 are provided as the main controller 511 and the height level controller 512 of FIG. 5, respectively.

The first to third interfaces 601 to 603 and the height level controller 612 may be configured the same as the first to third interfaces 401 to 403 and the height level controller 412, respectively, and therefore repetitive descriptions will be omitted to avoid redundancy.

The control device 610 is connected to first to k-th sensing devices SD1 to SDk through the first interface 601, connected to first to k-th servo motors 621 to 62k through the second interface 602, and connected to movement carriages 630 and nozzle assembly 640 through the third interface 603. The first to k-th sensing devices SD1 to SDk, the first to k-th servo motors 621 to 62k, the movement carriages 630, and the nozzle assembly 640 may be configured the same as the first to k-th sensing devices SD1 to SDk, the first to k-th servo motors 421 to 42k, the movement carriages 430, and the nozzle assembly 440 of FIG. 4, respectively. Overlapping descriptions will be omitted for conciseness.

The main controller 611 is connected to the height level controller 612 and the third and fourth interfaces 603 and 604. The fourth interface 604 may provide the main controller 611 with an interface with a LiDAR sensor LD. The LiDAR sensor LD may be the LiDAR sensor LD of FIG. 5, and may generate scan data including scan frames SF, each defining in three dimensional space physical objects, such as the structure BS in the site ST of construction and desired portions of the 3D printer system 500.

The main controller 611 may start building the structure BS by controlling the movement carriages 630 and the nozzle assembly 640 when the height level controller 612 generates a pass signal PS enabled. In addition, the main controller 611 may receive the scan frames SF through the fourth interface 604, and may control the movement carriages 630 and the nozzle assembly 640 based on the scan frames SF.

The main controller 611 may monitor the scan frames SF, and may recognize various events occurring during building construction based on the scan frames SF. For example, the main controller 611 may recognize at least one event of a difference in elevation of regions of the ground surface of the site ST, construction errors of at least one of components of the structure BS, and deformation of portions of the 3D printer system 500 such as the frame shafts VF1, VF2, HF, and SBF, and may control movement carriages 630 and the nozzle assembly 640 in response to the recognized event. The main controller 611 may control the nozzle assembly 640 to adjust amounts of materials discharged by the nozzle assembly 640, and may control the movement carriages 630 to adjust path and speed of the movement of the nozzle assembly 640.

Referring to FIG. 7 together with FIG. 6, while the 3D printer system 500 builds a layered structure LS of the structure BS of FIG. 5, the main controller 611 may recognize the event of a construction error at one of construction components of the layered structure LS. For example, the layered structure LS may have a construction error ER lower than a designed height DH at a coordinate (Xa, Xb) in the site ST in a plan view despite that the layered structure LS is required to have a flat upper surface as indicated by the dotted horizontal line of FIG. 7. The main controller 611 may recognize the construction error ER from the scan frames SF, and may control the movement carriages 630 and the nozzle assembly 640 based on the construction error ER. For example, the main controller 611 may control the nozzle assembly 640 to discharge more materials at and around the coordinate (Xa, Xb) when forming an upper layer disposed on the layered structure LS.

Referring to FIG. 8 together with FIG. 6, when the first and second vertical frame shafts VF1 and VF2 moves along the first and second base frames BF1 and BF2 in the second direction D2, the main controller 611 may recognize the event of deformation of at least one of the first and second vertical frame shafts VF1 and VF2. For example, the first and second vertical frame shafts VF1 and VF2 may be bent by a deformation value DV depending on their stiffness, the weight of elements of the 3D printer system 500 supported by the first and second vertical frame shafts VF1 and VF2, etc. when the first and second vertical frame shafts VF1 and VF2 move in the second direction D2. The main controller 611 may recognize the deformation value DV from the scan frames SF, and may control the movement carriages 630 and the nozzle assembly 640 based on the deformation value DV. For example, the main controller 611 may decrease a speed of movement of the first and second vertical frame shafts VF1 and VF2 (or the first and second horizontal movement carriages HMC1 and HMC2) in response to the deformation value DV greater than a threshold value. For another example, the main controller 611 may decrease a speed of movement of the first and second vertical frame shafts VF1 and VF2 as the deformation value DV increases. Here, the main controller 611 may control the nozzle assembly 640 to adjust the discharge amount of the materials according to the change in the speed of movement of the first and second vertical frame shafts VF1 and VF2. As such, the main controller 611 may request the scan frames SF from the LiDAR sensor LD with moving the movement carriages 630 to detect deformation values at the desired portions of the 3D printer system 500 such as the deformation value DV shown in FIG. 8.

As such, the main controller 611 may monitor the scan frames SF to control operations for building construction components, thereby minimizing construction errors and building construction components with relatively high reliability.

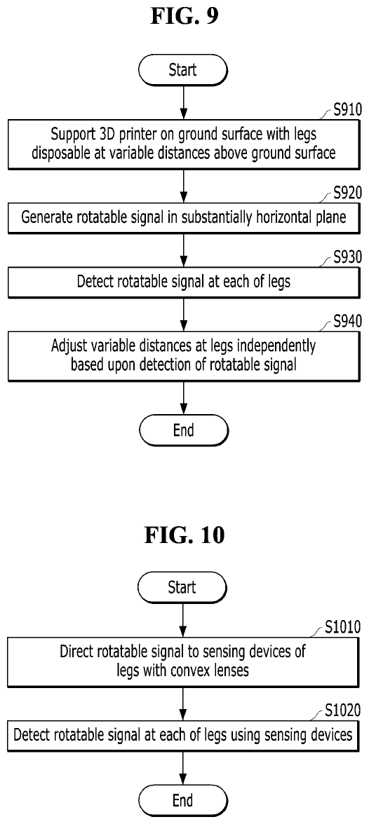

FIG. 9 is a flowchart of an embodiment of a method of maintaining a 3D printer system for building construction components in a substantially horizontal orientation according to the principles of the invention.

Referring to FIG. 9, at step S910, a 3D printer system is supported on the ground surface with legs. The legs may include portions of the 3D printer system that stand vertically on the ground surface to support other portions of the 3D printer system. For example, the legs may include the first and second vertical frame shafts VF1 and VF2 of FIG. 1.

Each of the legs of the 3D printer system is disposable at adjustable distances above the ground surface. In an embodiment, a height adjusting mechanism may be provided between the legs of the 3D printer system and the ground surface. For example, the height adjusting mechanism includes the height levelers HL of FIG. 1.

At step S920, a rotatable signal is generated in a substantially horizontal plane. The rotatable signal may include a laser signal rotating at a high speed. In an embodiment, the laser generator 121 of FIG. 2, which may maintain in a substantially horizontal orientation, may be positioned at the center of the 3D printer system when viewing from above, and the laser generator 121 may be controlled to generate the rotating laser signal. Accordingly, the rotating laser signal may be generated in the substantially horizontal plane.

At step S930, the rotatable signal is detected at each of the legs using sensing devices disposed on the legs. In an embodiment, the sensing device includes a plurality of light sensors arranged in a vertical direction, such as the upper, lower, and center light sensors IS1, IS2, and IS3 of FIG. 3.

At step S940, the variable distances are adjusted at the legs independently based upon detection of rotatable signal at each of the legs. The variable distance may increase when the detection of rotatable signal at the sensing device of the leg indicates that a reference point of the sensing device is positioned lower than the horizontal plane of the rotatable signal. The variable distance may decrease when the detection of rotatable signal at the sensing device of the leg indicates that the reference point of the sensing device is positioned higher than the horizontal plane of the rotatable signal. As such, the variable distances may be adjusted at the legs independently based on detection of rotatable signal at each of the legs, and thereby improving horizontality of the 3D printer system and building construction components with relatively high reliability.

FIG. 10 is a flowchart of an embodiment of step S930 of FIG. 9.

Referring to FIG. 10, at step S1010, the rotatable signal is directed to the sensing devices of the legs with convex lenses. The convex lenses may be installed on the legs to direct the rotatable signal to the sensing devices of the legs as shown in FIG. 2.

At step S1020, the rotatable signal is detected at each of the legs using the sensing devices.

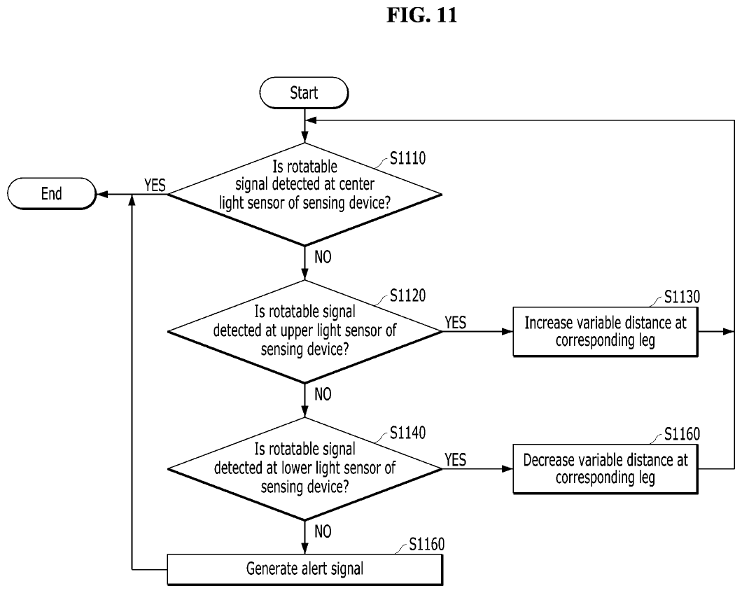

FIG. 11 is a flowchart of an embodiment of step S940 of FIG. 9.

Referring to FIG. 11, at step S1110, it is determined that the rotatable signal is detected at a center light sensor of the sensing device. In an embodiment, the sensing device includes a plurality of light sensors arranged in a vertical direction, such as an upper light sensor, a lower light sensor disposed between the upper light sensor and the ground, and a center light sensor disposed between the upper light sensor and the lower light sensor, as the light sensors IS1 to IS3 shown in FIG. 3. The center light sensor may be understood as the reference point of the sensing device that needs to be aligned with the horizontal plane of the rotatable signal. If the rotatable signal is detected at the center light sensor, the adjustment of the variable distance at the corresponding leg may be finished. If the rotatable signal is not detected at the center light sensor, step S1120 is performed.

At step S1120, it is determined that the rotatable signal is detected at the upper light sensor of the sensing device. If the upper light sensor detects the rotatable signal, it means that the reference point of the sensing device is lower than the horizontal plane of the rotatable signal. At step S1130, the variable distance at a corresponding leg is adjusted to increase. If the upper light sensor does not detect the rotatable signal, step S1140 is performed.

At step S1140, it is determined that the rotatable signal is detected at the lower light sensor of the sensing device. If the lower light sensor detects the rotatable signal, it means that the reference point of the sensing device is higher than the horizontal plane of the rotatable signal. At step S1150, the variable distance at a corresponding leg is adjusted to decrease. Steps S1110 to S1150 may be repeated until the center light sensor detects the rotatable signal.

If all the light sensors of the sensing device fails to detect the rotatable signal, an alert signal may be generated associated with a corresponding leg to inform the user that the variable distance at the corresponding leg is out of a range adjustable by the automatic leveling system. As such, an alert signal may be generated when any one of the sensing devices of the legs of the 3D printer system fails to detect the rotatable signal. For example, the alert signal may be output through output devices such as display and/or audio devices. At step S1160, the alert signal may be generated if the lower light sensor does not detect the rotatable signal.

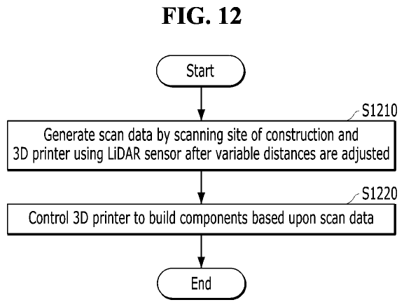

FIG. 12 is a flowchart of an embodiment of a method of controlling a 3D printer system after horizontality of the 3D printer system is adjusted.

Referring to FIG. 12, at step S1210, scan data is generated by scanning a construction site and a 3D printer system using LiDAR sensor after variable distances at legs of the 3D printer system are adjusted as described with reference to FIG. 9. For example, the scan data is generated when the 3D printer system builds construction components. For example, the LiDAR sensor LD may generate optical pulses and then measures the characteristics of the reflected optical pulses such as pulse powers, round trip times, phase shifts, pulse widths, etc. to detect and define objects in the field of view to generate the scan data.

At step S1220, the 3D printer system is controlled to build the construction components based upon the scan data. For example, elements of the 3D printer system, such as a nozzle assembly and movement carriages of frame shafts, may be controlled based upon the scan data to build the construction components. As such, the scan data may be monitored to control operations for building construction components, thereby minimizing construction errors and building construction components with relatively high reliability

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. An automatic leveling system to maintain a 3D printer for building construction components in a substantially horizontal orientation, the automatic leveling system comprising:
a support structure to support on a ground surface at least two columns each being supportable at a variable distance above the ground surface;
a signal generator to generate a rotatable signal in a substantially horizontal plane; and
sensors mounted on the columns to detect the rotatable signal,
wherein the variable distances are adjustable based on the detection of the rotatable signal by the sensors.

2. The automatic leveling system of claim 1, wherein the columns comprise legs having substantially constant lengths and a height adjusting mechanism to adjust the variable distances independently based on the detection of the rotatable signal at the sensors.

3. The automatic leveling system of claim 1, wherein the support structure comprises:
base members to horizontally support the columns; and
outriggers to horizontally fix the base members to the ground surface.

4. The automatic leveling system of claim 1, wherein the rotatable signal comprises a laser signal and the signal generator comprises a laser generator to generate the laser signal.

5. The automatic leveling system of claim 1, wherein at least one of the sensors comprises a first light sensor disposed above the ground surface and a second light sensor disposed closer to the ground surface than the first light sensor.

6. The automatic leveling system of claim 5, wherein the automatic leveling system further comprises a height level controller to generate:
a first control signal to increase the variable distance of one of the columns connected to the first light sensor in response to detection of the rotatable signal at the first light sensor; and
a second control signal to decrease the variable distance of one of the columns connected to the second light sensor in response to detection of the rotatable signal at the second light sensor.

7. The automatic leveling system of claim 6, wherein:
the at least one of the sensors further comprises a third light sensor disposed between the first and second light sensors; and
the height level controller is configured to maintain the variable distance of one of the columns connected to the third light sensor substantially constant in response to detection of the rotatable signal at the third light sensor.

8. The automatic leveling system of claim 1, further comprising convex lenses to direct the rotatable signal to the sensors, respectively.

9. The automatic leveling system of claim 1, further comprising:
a servo motor to rotate in response to a control signal based on one of the sensors detecting the rotatable signal; and
a screw jack engaged with the servo motor to increase or decrease the variable distance of one of the columns connected to the one of the sensors in response to the rotation of the servo motor.

10. The automatic leveling system of claim 1, further comprising a LiDAR (Light Detection And Ranging) sensor to at least partially scan one or more of a construction site and the 3D printer to generate scan data to control the 3D printer.

11. The automatic leveling system of claim 10 in combination with a 3D printer for building construction, and further comprising:
a nozzle to discharge materials to build the construction components;
frame shafts connected to the columns to support the nozzle;
a moving mechanism supported by the columns and the frame shafts to move the nozzle relative to the support structure; and
a main controller to receive the scan data and to control the moving mechanism and the nozzle based on the scan data.

12. The apparatus of claim 11, wherein the main controller is configured to recognize, based on the scan data, at least one event of a difference in elevation of regions of the ground surface, construction errors of at least one of the construction components, and deformation of at least one of portions of the columns and the frame shafts, and to control the moving mechanism and the nozzle in response to the recognized event.

13. The apparatus of claim 11, wherein the main controller is configured to control the LiDAR sensor to generate the scan data when the moving mechanism moves relative to the support structure and to adjust, based on the scan data, at least one of amounts of material discharged by the nozzle, a path of movement of the nozzle, a speed of the movement of the nozzle.

14. A method of maintaining a 3D printer for building construction components in a substantially horizontal orientation, the method comprising the steps of:
supporting the 3D printer on a ground surface with at least two members being adjustable at variable distances above the ground surface;
generating a rotatable signal in a substantially horizontal plane;
detecting the rotatable signal at each of the members; and
adjusting the variable distances based upon the detection of the rotatable signal.

15. The method of claim 14, wherein the rotatable signal comprises a laser signal.

16. The method of claim 14, wherein:
the step of detecting the rotatable signal comprises detecting the rotatable signal at first and second light sensors disposed at different heights relative to the ground surface; and
the step of adjusting the columns comprises:
increasing the variable distance of one of the members when the rotatable signal is detected at the first light sensor; and
decreasing the variable distance of one of the members when the rotatable signal is detected at the second light sensor.

17. The method of claim 16, wherein the step of adjusting the variable distances further comprises:
maintaining the variable distance of one of the members substantially constant when the rotatable signal is detected at a third light sensor disposed between the first and second light sensors.

18. The method of claim 14, wherein the step of detecting the rotatable signal comprises:
directing the rotatable signal to sensors with convex lenses; and
the step of adjusting the variable distances comprises generating an alert signal when one of the sensors fails to detect the rotatable signal.

19. The method of claim 14, further comprising the steps of i) generating scan data by at least partially scanning one or more of a construction site and the 3D printer using a LiDAR sensor after the variable distances are adjusted; and ii) controlling the 3D printer to build the construction components based upon the scan data.

20. A 3D printer system for building construction components to maintain the 3D printer in a substantially horizontal orientation, the system comprising:
at least two outriggers to support on a ground surface at least two members of a frame supporting the 3D printer;
a signal generator to generate a rotatable signal in a substantially horizontal plane;
sensors disposed on the members to detect the rotatable signal; and
a height adjusting mechanism to adjust heights of the members independently based on the sensors detecting the rotatable signal.
